(19) United States
(12) Patent Application Publication
(10) Pub. No.: US 2018/0343432 A1
(43) Pub. Date: Nov. 29, 2018

(54) Reducing Blur in a Depth Camera System

(71) Applicant: Microsoft Technology Licensing, LLC, Redmond, WA (US)

(72) Inventors: Xin DUAN, Bothell, WA (US); Raymond Kirk PRICE, Redmond, WA (US); Denis Claude Pierre DEMANDOLX, Bellevue, WA (US)

(21) Appl. No.: 15/603,409

(22) Filed: May 23, 2017

(51) Int. Cl. H04N 13/02; G06T 5/00; G06T 5/20; H04N 13/04; G01S 17/89; G01S 17/08

(52) U.S. Cl. CPC H04N 13/0271; H04N 13/0253; G06T 5/003; G06T 2207/10028; H04N 13/044; G01S 17/89; G01S 17/08; G06T 5/20

(57) ABSTRACT

A technique is described herein for reducing blur caused by an imaging assembly of a depth camera system. In a runtime phase, the technique involves receiving a sensor image that is generated in response to return radiation reflected from a scene. The return radiation passes through an optical element (such as a visor element) of the imaging assembly, which produces blur due to the scattering of radiation. The technique then deconvolves the sensor image with a kernel, to provide a blur-reduced image. The kernel represents a point spread function that describes the distortion-related characteristics of at least the optical element. The technique then uses the blur-reduced image to calculate a depth image. The technique also encompasses a calibration-phase process for generating the kernel by modeling blur that occurs near an edge of a test object within a test image.

### BACKGROUND

A time-of-flight (ToF) depth camera system includes an illumination source and a sensor operating in coordination with each other. The illumination source projects infrared radiation onto a scene. The sensor receives resultant infrared radiation that is reflected from the scene, and, in response thereto, provides a plurality of sensor signals. The signals provide information which relates to an amount of time it takes the radiation to travel from the illumination source to the sensor, for a plurality of points in the scene. A processing component converts the sensor signals into depth values, each of which describes the distance between a point in the scene and a reference point. The depth values collectively correspond to a depth image. A post-processing component may thereafter leverage the depth image to perform some context-specific task, such as providing a mixed-reality experience in a head-mounted display (HMD), controlling the navigation of a vehicle, producing a three-dimensional reconstruction of the scene, etc.

A ToF depth camera system is highly susceptible to noise that originates from various sources. The noise can cause the depth camera system to generate inaccurate depth values, which, in turn, may degrade the performance of any post-processing component that relies on the depth values. This makes a depth camera system different from a conventional video camera, in which noise only causes an aesthetic degradation of an image.

### SUMMARY

A technique is described herein for reducing blur caused by an imaging assembly of a depth camera system. More specifically, in one implementation, the technique reduces blur principally caused by the light-scattering behavior of an optical element (OE) of a time-of-flight depth camera system. In one non-limiting example, the optical element corresponds to a transparent visor element of a head-mounted display (HMD), through which radiation passes to and from the HMD's depth camera system.

In a runtime phase, the technique generates a sensor image in response to return radiation that is reflected from an object in a scene. The return radiation is scattered as it passes through the optical element, which causes blur in the sensor image. The technique then deconvolves the sensor image with a kernel, to provide a blur-reduced image. The kernel represents a point spread function (PSF) that describes the distortion-related characteristics of at least the optical element. The technique then uses the blur-reduced image (together with other blur-reduced images) to calculate a depth image.

In a calibration phase, the technique generates the PSF based on a line spread function. The technique generates the line spread function, in turn, by modeling blur that occurs near an edge of a test object within a test image. That blur is principally caused by radiation scattered by the optical element.

The above technique can be manifested in various types of systems, devices, components, methods, computer-readable storage media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of a calibration system for generating a kernel in a calibration phase, and a depth camera system for applying the kernel in a runtime phase.

FIG. 2 shows a depth image produced by a depth camera system that does not use a visor element.

FIG. 3 shows a depth image produced by a depth camera system that uses a visor element.

FIG. 4 shows one implementation of a conversion component and a depth-computing component, which are elements of the depth camera system of FIG. 1.

FIG. 5 shows a representation of an active brightness value and a phase value that the conversion component computes on the basis of plural sensor images associated with different phases.

FIG. 6 shows one technique for determining a distance at which an object is placed in a scene based on plural phase values measured at plural respective frequencies.

FIG. 7 show one implementation of the calibration system introduced in FIG. 1.

FIG. 8 shows pixels near an edge of a test object. The calibration system uses the intensities of these pixels to generate a line spread function.

FIG. 9 shows one technique for generating the line spread function based on the intensities of the pixels shown in FIG. 8.

FIG. 10 shows different line spread functions produced by the calibration system.

FIG. 11 shows one technique for generating a point spread function based on a line spread function.

FIG. 12 shows one implementation of a blur-mitigating component, which is an element of the depth camera system of FIG. 1.

FIG. 13 shows one manner of operation of a region-selecting component, which is an element of the blur-mitigating component of FIG. 12.

FIG. 14 shows one implementation of a head-mounted display, which includes the depth camera system of FIG. 1.

FIG. 15 shows illustrative structural aspects of the head-mounted display of FIG. 14.

FIG. 16 shows a process that describes an overview of one manner of operation of the calibration system of FIG. 7.

FIG. 17 shows a process that describes a verification operation performed by the calibration system of FIG. 7.

FIG. 18 shows a process that describes one way that the calibration system can generate a line spread function.

FIG. 19 shows a process that describes an overview of one manner of operation of the depth camera system of FIG. 1 in a runtime phase.

FIG. 20 shows illustrative computing functionality that can be used to implement any aspect of the features shown in the foregoing drawings.

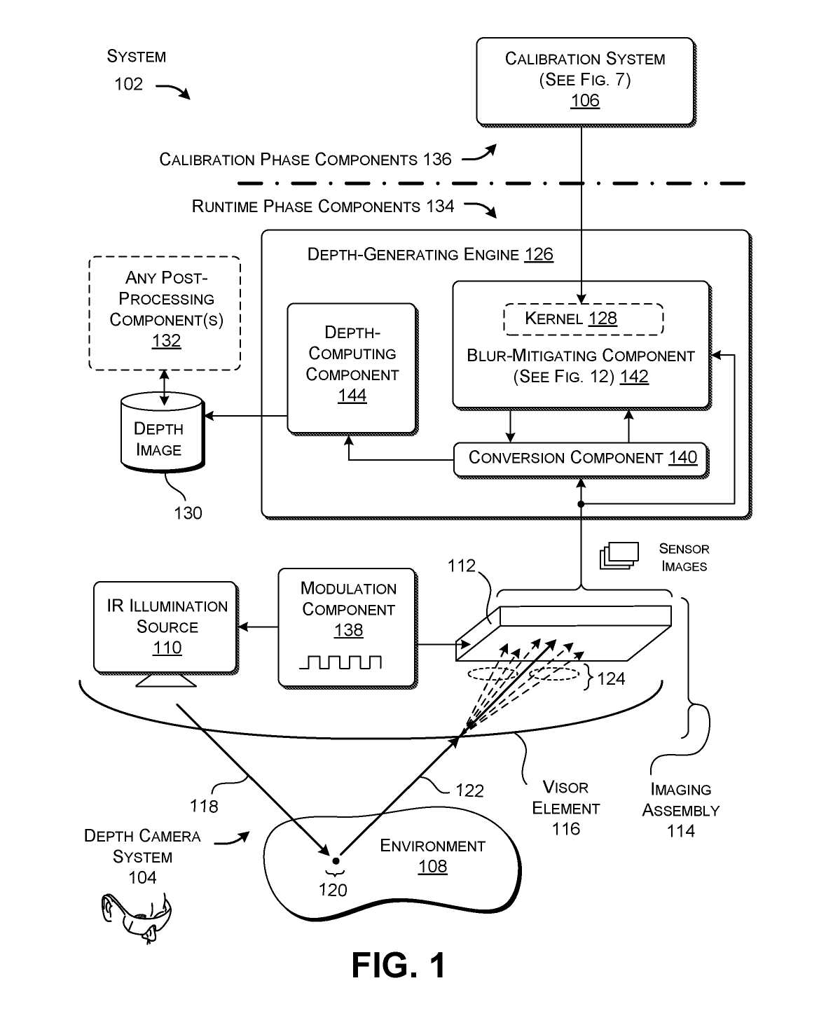

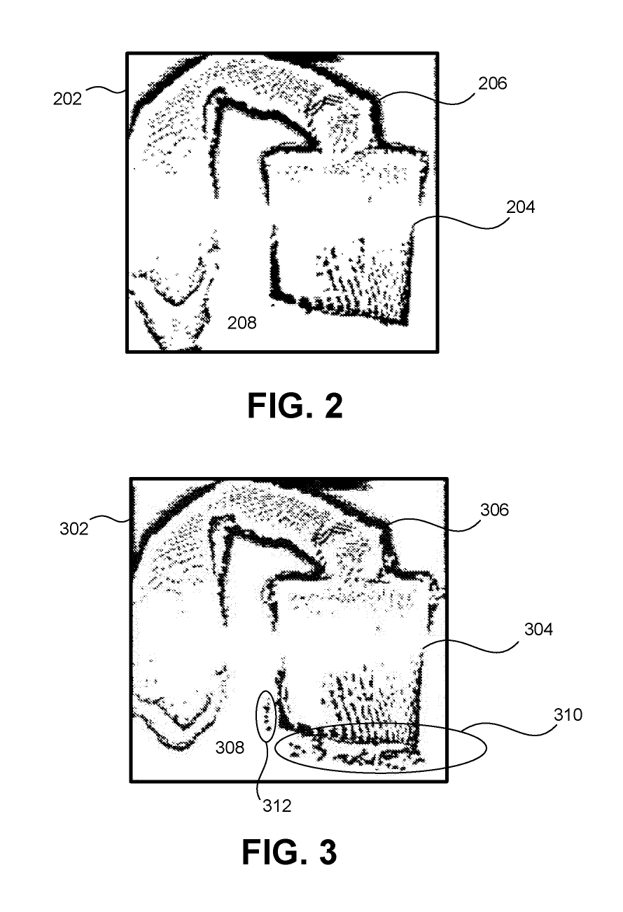

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes a calibration system that generates a kernel, and a time-of-flight (ToF) depth camera system that applies the kernel to reduce the effects of blur caused, in part, by an optical element used by the depth camera system, such as a visor element of a head-mounted display (HMD). Section B describes one implementation of an HMD that can incorporate the depth camera system of Section A. Section C describes the operation of the equipment described in Section A in flowchart form. And Section D describes illustrative computing functionality that can be used to implement any aspect of the features described in the preceding sections.

As a preliminary matter, some of the figures describe concepts in the context of one or more structural components, also referred to as functionality, modules, features, elements, etc. In one implementation, the various components shown in the figures can be implemented by software running on computer equipment, or other logic hardware (e.g., FPGAs), etc., or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. Section D provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts can be implemented by software running on computer equipment, or other logic hardware (e.g., FPGAs), etc., or any combination thereof.

As to terminology, the phrase “configured to” encompasses various physical and tangible mechanisms for performing an identified operation. The mechanisms can be configured to perform an operation using, for instance, software running on computer equipment, or other logic hardware (e.g., FPGAs), etc., or any combination thereof.

The term “logic” encompasses various physical and tangible mechanisms for performing a task. For instance, each operation illustrated in the flowcharts corresponds to a logic component for performing that operation. An operation can be performed using, for instance, software running on computer equipment, or other logic hardware (e.g., FPGAs), etc., or any combination thereof. When implemented by computing equipment, a logic component represents an electrical component that is a physical part of the computing system, in whatever manner implemented.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific terms “computer-readable storage medium” and “computer-readable storage medium device” expressly exclude propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative System for Reducing Blur

A.1. Overview

FIG. 1 shows a system 102 that includes a depth camera system 104 and a calibration system 106. The depth camera system 104 uses a phase-based time-of-flight (ToF) technique to determine the depths of points in an environment 108. The depth camera system 104 can optionally be incorporated into a more encompassing device, such as a head-mounted display (HMD). Section B (below) describes one such illustrative HMD. Alternatively, or in addition, the depth camera system 104 can work in conjunction with a separate processing system, such as a separate gaming system or an environment-modeling system.

By way of overview, the depth camera system 104 includes an illumination source 110 for emitting electromagnetic radiation, such as, without limitation, infrared radiation having wavelengths in the range of 700 nm and 1000 nm. A diffuser element (not shown) can spread the infrared radiation over the environment 108 in a uniform manner. The infrared radiation impinges the environment 108 and is reflected therefrom. A sensor 112 detects the reflected radiation using a plurality of sensing elements, and generates a plurality of signals in response thereto. Each signal conveys the correlation between an instance of forward-path radiation (at the time it is emitted by the illumination source 110) and a corresponding instance of return-path radiation that is reflected from the environment 108 (at the time it is received by the sensor 112). The signals produced by all of the sensing elements at any given sampling time correspond to a sensor image.

The sensor 112 is one part of an imaging assembly 114. The imaging assembly 114 also includes one or more lenses (not shown) and a visor element 116. The visor element 116 corresponds to a transparent member through which forward-path radiation passes on its way from the illumination source 110 to the environment 108, and through which return-path radiation passes on its way from the environment 108 to the sensor 112. In the context of a head-mounted display, the visor element 116 acts as a shield which protects the illumination source 110, the imaging assembly 114, and other components of the depth camera system 104. A designer may also use the visor element 116 for aesthetic reasons, e.g., to give the head-mounted display a sleek and uncluttered appearance. The visor element 116 may be built using a plastic material, a glass material, and/or any other transparent material(s). In some cases, the visor element 116 is tinted; in other cases, the visor element 116 has no tint.

Note, however, that the principles described herein are applicable to any optical element through which radiation passes. An HMD visor represents just one concrete example of such an optical element. Generally, the optical element can serve different purposes in different respective implementations. For instance, in a vehicle navigation context, the optical element may correspond to a transparent shield mounted to a vehicle that protects the illumination source 110 and the imaging assembly 114. In other contexts, the optical element corresponds to one or more lenses which focus radiation. However, to facilitate explanation, the Detailed Description will emphasize the non-limiting and representative example in which the optical element corresponds to a visor element, and, more specifically, an HMD visor element.

The visor element 116 may suffer from imperfections caused by the manufacturing process and/or other factors. These imperfections scatter at least some of the radiation that passes through it. This results in blur in the sensor image captured by the sensor 112. For example, consider an instance of forward-path radiation 118 that originates from the illumination source 110, passes through the visor element 116, and strikes a point 120 on a surface in the environment 108. In a return path, an instance of return-path radiation 122 is reflected from the point 120, passes through the visor element 116, and impinges on the surface of the sensor 112. FIG. 1 specifically shows the effects of radiation scattering 124 as the return-path radiation 122 passes through the visor element 116. As shown, the scattering 124 diffuses the return-path radiation 122, that is, by causing it to spread out. As a result, parts of the return-path radiation 122 may strike several sensing elements of the sensor 112. Without the visor element 116, the return-path radiation 122 would not suffer from the scattering 124 to the extent shown, and therefore would impinge fewer sensing elements of the sensor 112.

To clarify, the anomalies in the visor element 116 can cause diffusion that affects both the forward-path radiation 118 and the return-path radiation 122. However, the performance of the depth camera system 104 is much more negatively affected by the scattering in the return-path radiation 122, compared to the scattering in the forward-path radiation 118. Hence, FIG. 1 illustrates only the scattering 124 that affects the return-path radiation 122.

A depth-generating engine 126 processes the sensor images provided by the sensor 112, to generate a depth image. The depth image reflects the distance between a reference point and a plurality of points in the environment 108. The reference point generally corresponds to the location of the depth camera system 104 that emits and receives the infrared radiation. For instance, when the depth camera system 104 is incorporated into a head-mounted display, the reference point corresponds to a reference location associated with the head-mounted display.

The depth-generating engine 126 uses a kernel 128 to reduce the effects of blur in the sensor images that is caused by the image assembly 114, and is particularly attributed to the visor element 116. The depth-generating engine 126 performs this task by deconvolving the sensor images with the kernel 128, to produce blur-reduced images. The depth-generating engine 126 computes the depth image based on the blur-reduced images. A data store 130 stores the depth image.

As will be described below in greater detail, in some implementations, the depth-generating engine 126 performs the deconvolving operation by first selecting a sub-region of each sensor image to which the kernel 128 is to be applied. The depth-generating engine 126 then selectively applies the kernel 128 to that sub-region. In other implementations, the depth-generating engine 126 applies the kernel 128 to the entirety of each sensor image.

One or more post-processing components 132 can further process the depth image in accordance with various use scenarios. For example, in one use scenario, a head-mounted display uses the depth image to determine the relation of a user to different objects in the environment 108, e.g., for the ultimate purpose of generating a mixed-reality experience, also referred to as an augmented-reality experience. In another use scenario, a navigation system uses the depth image to determine the relation of a mobile agent (such as a vehicle, drone, etc.) to the environment 108, for the ultimate purpose of controlling the movement of the mobile agent in the environment. In another use scenario, a modeling system uses the depth image to generate a three-dimensional representation of objects within the environment 108, and so on. These post-processing contexts are cited by way of example, not limitation; the depth camera system 104 can be used in other use scenarios.

Overall, the depth camera system 104 corresponds to a set of runtime-phase components 134. The runtime-phase components 134 provide their service during the intended use of the depth camera system 104, e.g., in the course of providing a mixed-reality experience.

The calibration system 106 performs the primary task of generating the kernel 128 that is used by the depth-generating engine 126. The calibration system 106 performs this task by using the same imaging assembly 114 to produce a test image that captures at least one test object. The calibration system 106 generates a line spread function (LSF) that models the blur that occurs in the test image in proximity to an edge of the test object. The calibration system 106 then generates a point spread function (PSF) based on the LSF. The PSF describes the distortion-related characteristics of at least the visor element 116. Finally, the calibration system 106 produces an n×n kernel 128 that represents a discretized version of the PSF. Each of these operations will be described in detail below.

The calibration system 106 corresponds to a set of calibration-phase components 136. The calibration-phase components 136 perform their work in a preparatory stage, prior to the runtime phase. For example, the calibration system 106 may generate a unique kernel for each depth camera system 104 (and its unique visor element 116) in a factory setting. Alternatively, or in addition, the calibration system 106 may provide a configuration routine that allows an end user to generate a new kernel. An end user may wish to perform this task to address degradation in the visor element 116 that occurs over a span of time, or to create a kernel for a newly installed visor element 116, such as a replacement visor element.

Advancing momentarily to FIGS. 2 and 3, FIG. 2 shows a depth image 202 produced by the depth camera system 104 without the use of the visor element 116. In that depth image 202, a user holds an object 204 having a highly Lambertian reflective surface (here corresponding to a white piece of paper) in his or her hand 206. The object 204 appears in the foreground against a relatively remote background 208.

FIG. 3 shows another depth image 302 produced by the depth camera system 104, this time using the visor element 116. Further assume that the depth-generating engine 126 does not yet perform the above-described blur-reducing technique using the kernel 128. A user again holds an object 304 having a highly Lambertian reflective surface in his or her hand 306. The object 304 appears in the foreground against a relatively remote background 308. Note that, compared to the depth image 202, the depth image 302 also includes blur artifacts (e.g., in regions 310 and 312) near the edge of the relatively bright object 304. These blur artifacts correspond to incorrect depth values that may be primarily attributed to the scattering 124 that occurs in the visor element 116. As a general observation, note that the depth image 302 is particularly susceptible to blur artifacts in those regions at which a bright object is juxtaposed against a low-intensity region, e.g., in this case associated with the remote background 308.

The blur artifacts shown in FIG. 3 represent phantom surfaces that do not exist in the real-world scene. Alternatively, or in addition, the visor element 116 can cause inaccurate depth values associated with an existing surface in the scene. For instance, assume that a true depth of a surface point is d_{correct}; the scattering 124 produced by the visor element 116 can cause the depth-generating engine 126 to calculate the depth as d_{correct}+error.

Some use scenarios make the depth capture system 104 particularly susceptible to the kind of noise described above. For instance, an HMD may require that the depth camera system 104 produce accurate depth values for a wide range of distance values (d) (relative to the position of the HMD), such as distances ranging from 0.5 meters to 4 meters. The HMD may also require the depth camera system 104 to produce accurate depth values for a wide range of reflectivity values (R), such as reflectivity values between 3% and 100%. The active brightness (defined below) of a scene point is proportional to R×1/d². Given the above-noted wide variance in R and d, the active brightness relationship means that the HMD is required to process a wide range of active brightness values, and a corresponding wide range of sensor signal values (from which the active brightness values are computed). This raises a challenge because some of the noise shown in FIG. 3 may be on the same order of magnitude as meaningful (yet weak) sensor signals, making it problematic to discriminate between noise and meaningful signals. It is not prudent to eliminate the weaker signals because those signals may be associated with meaningful scene information, e.g., corresponding to an object that is relatively far from the HMID, and/or an object that has relatively low reflectively characteristics.

The depth-generating engine 126 can eliminate or at least reduce the blur artifacts by deconvolving the sensor images with the kernel 128. This blur-reducing operation overall produces a more accurate depth image. In a head-mounted display experience, the blur-reducing operation produces a representation of surfaces in a scene having a reduced amount of visual noise.

This subsection continues by providing further details regarding the depth camera system 104 of FIG. 1. Subsection A.2 provides further details regarding the calibration system 106, and Subsection A.3 provides yet additional information regarding the runtime-phase blur-removing aspects of the depth camera system 104.

Returning to the depth camera system 104 of FIG. 1, the illumination source 110 may correspond to a laser or a light-emitting diode, or some other source of electromagnetic radiation in the infrared spectrum and/or some other portion(s) of the spectrum. A modulation component 138 controls the illumination source 110 to produce an amplitude-modulated continuous wave of radiation, e.g., corresponding to a square wave, a sinusoidal wave, or some other periodic signal having a frequency ω.

The sensor 112 can be implemented as a Complementary Metal-Oxide-Semiconductor (CMOS) sensor having a plurality of sensing elements. Each sensing element receives an instance of reflected radiation and generates a sensor reading in response thereto. A sensor signal expresses the correlation between an instance of the forward-path radiation (at the time of its generation by the illumination source 110) and a corresponding instance of return-path radiation (at the time of it reception by the sensor 112), where that return-path radiation is reflected by point on a surface in the environment 108. The correlation, in turn, expresses the manner in which the received return-path radiation has shifted relative to the emitted forward-path radiation. The shift between the two instances of radiation relates to an amount of time Δt between the emission of the forward-path radiation and the receipt of the corresponding return-path radiation. The depth camera system 104 can calculate the depth of a point in the environment based on Δt and the speed of light c. As stated above, at any given sampling time, the sensing elements produce a plurality of signals of the above-described type, which collectively form a sensor image. A sensor image may also be considered as an input image, since it is an input to later-stage computations (described below).

The sensor 112 includes a global shutter that is driven by the same modulation component 138. The global shutter controls the timing at which the sensing elements accumulate charge and subsequently output their sensor signals. This configuration allows the depth camera system 104 to coordinate the modulation timing of the illumination source 110 with the sensor 112.

Overall, the depth camera system 104 produces a set of sensor images for use in determining the depth values in a single depth image. For instance, the depth camera system 104 can drive the illumination source 110 to sequentially produce transmitted signals having N different frequencies. And for each frequency, the depth camera system 104 can drive the sensor 112 such that it captures a scene at M different phase offsets relative to a corresponding transmitted signal. Hence, the depth camera system 104 collects N×M sensor readings for each depth measurement.

For instance, in one non-limiting case, the depth camera system 104 operates using three (N=3) different frequencies (f₁, f₂, f₃) and three (M=3) different phase offsets (θ₁, θ₂, θ₃). To perform this operation, the depth camera system 104 can collect nine sensor images in the following temporal sequence: (f₁, θ₁), (f₁, θ₂), (f₁, θ₃), (f₂, θ₁), (f₂, θ₂), (f₂, θ₃), (f₃, θ₁), (β, θ₂), and (f₃, θ₃). In one implementation, θ₁=0 degrees, θ₂=120 degrees, and θ₃=240 degrees. Generally, the depth camera system 104 collects sensor images at different phase offsets and frequencies to supply enough information to resolve inherent ambiguity in the depth of points in a scene (as described in greater detail below).

Now referring to the depth-generating engine 126, a conversion component 140 converts the set of raw sensor values into a higher-level form. For example, consider the operation of the conversion component 140 with respect to the processing of nine sensor readings produced by a single sensing element of the sensor 112. The conversion component 140 can represent the three sensor readings for each frequency as a single vector in the complex domain having real and imaginary axes. The angle of the vector with respect to the real axis (in the counterclockwise direction) corresponds to phase (φ), and the magnitude of the vector corresponds to active brightness (AB). The phase generally corresponds to the distance between a reference point and a point in the scene that has been imaged. The active brightness generally corresponds to the intensity of radiation detected by the sensing element.

Altogether, the conversion component 140 produces a set of phase measurements and a set of active brightness measurements for each sensor element. That is, in the example in which the depth camera system 104 uses three frequencies, the conversion component 140 produces three candidate phase measurements (φ_{f1}, φ_{f2}, φ_{f3}) and three active brightness measurements (AB_{f1}, AB_{f2}, AB_{f3}) for each sensor element. With respect to the sensor 112 as a whole, the conversion component 140 produces three active brightness images, each of which includes a plurality of AB measurements associated with different sensor elements (and corresponding pixels), with respect to a particular frequency. Similarly, the conversion component 140 also produces three phase images, each of which includes a plurality of phase measurements associated with different sensor elements, with respect to a particular frequency.

Note, however, that, at his stage, the depth-generating engine 126 has not yet addressed the possible occurrence of blur in the sensor images. Therefore, in one implementation, the conversion component 140 may delay the computation of the phase images until the blur has been removed or reduced.

A blur-mitigating component 142 performs two tasks. First, it identifies the sub-region(s) in a sensor image that may contain blur due to the visor element 116. Second, the blur-mitigating component 142 reduces the blur in the sensor image by deconvolving the sub-region(s) with the kernel 128. Subsection A.3 explains in detail how the blur-mitigating component 142 performs these two tasks. By way of preview, consider an AB image that is formed on the basis of three lower-level sensor images. The blur-mitigating component 142 can find one or more sub-regions in the AB image that meet certain brightness-related criteria (described below). Those sub-region(s) have corresponding sub-regions (having the same positions) in each of the three input sensor images. The blur-mitigating component 142 then deconvolves the kernel 128 with the sub-regions of the sensor images. This yields blur-reduced images.

At this juncture, the conversion component 140 can re-compute the phase images based on the blur-reduced sensor images. Or if this operation has not yet been performed, the conversion component 140 can compute the phase images for the first time.

A depth-computing component 144 processes the set of phase images to determine a single distance image. In one implementation, the depth-computing component 144 performs this task using a lookup table to map, for each sensor element, the three phase measurements (specified in the three phase images) into a distance value.

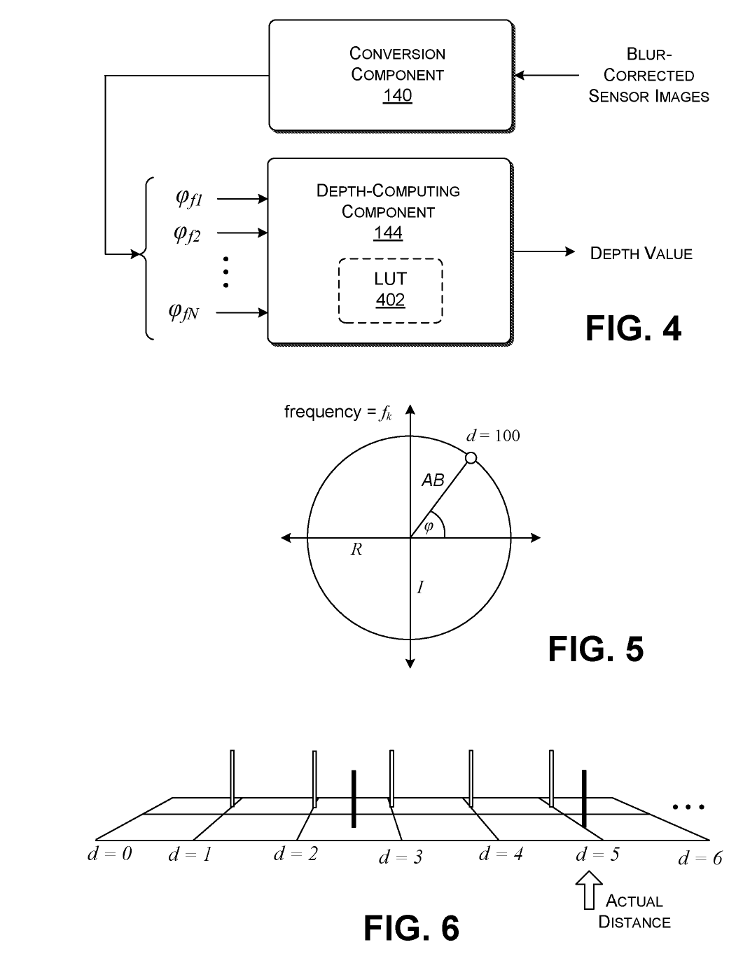

FIG. 4 provides further details regarding the operation of the conversion component 140 and the depth-computing component 144, with respect to the processing of signals associated with a single sensing element of the sensor 112. The conversion component 140 converts a set of sensor signals provided by the sensing element for a given frequency (fₖ) into a vector within a complex domain having real (R) and imaginary (I) axes. In one implementation, the conversion component 140 can determine the real and imaginary components associated with a related collection of sensor readings using the following two equations:

$$\begin{matrix}R = {\sum }_{i = 1}^{M} {S}_{i} cos ( \frac{2 π}{M} ) , and & ( 1 ) \\ I = {\sum }_{i = 1}^{M} {S}_{i} sin ( \frac{2 π}{M} ) . & ( 2 )\end{matrix}$$

In these equations, M refers to the number of sensor readings that are taken by the sensing element at different respective phase offsets, for the particular frequency fₖ. In the above non-limiting example, M=3. Sᵢ refers to a sensor signal value taken at a particular phase offset.

The conversion component 140 next determines a phase measurement (φ) and an active brightness (AB) for each real and imaginary value that it computes for the particular sensor element under consideration. Generally, the phase measurement reflects the angular relation of a vector in the complex domain with respect to the real axis, in the counterclockwise direction. The active brightness measurement reflects the magnitude of the vector. In one implementation, the following equations can be used to compute the phase measurement and the active brightness measurement:

φ=tan⁻¹(I/R) (3),

and

AB=\sqrt{R²+I²} (4).

FIG. 5 shows a vector generated by the conversion component 140 (for a given frequency fₖ). Note that any individual phase measurement can potentially map to plural candidate distance measurements. For example, a phase measurement of 70 degrees can refer to 70 degrees or any multiple of 360+70 degrees, corresponding to one or more revolutions of the vector around the origin of the complex domain. Each revolution is commonly referred to as a “wrap.” In other words, the measured phase corresponds to φ, but the actual phase may correspond to any angle defined by \hat{φ}=2πn+φ, where n refers to the number of wraps around the origin of the complex domain. For any particular depth measurement, different frequencies may produce phase measurements associated with different wrap integers, e.g., n_{f1}, n_{f2}, and n_{f3}.

The depth camera system 104 produces sensor readings for different frequencies for the principal purpose of resolving the ambiguity associated with any individual phase measurement. For example, as shown in FIG. 6, assume that the conversion component 140 indicates, based on its processing of signals collected using a first frequency, that there are at least five candidate depth values (e.g., at depths 1.0, 2.0, 3.0, 4.0, and 5.0). Assume further that the conversion component 140 indicates, based on its processing of signals collected using a second frequency, that there are at least two candidate depth values (e.g., at depths 2.5 and 5.0). The depth-computing component 144 can therefore choose the depth value at which the conversion component 140 produces consistent results with respect to plural frequencies, here being d=5. This task logically involves intersecting the candidate depths associated with different frequencies.

More specifically, in one implementation, the depth-computing component 144 receives the three phase measurements that have been computed by the conversion component 140 for the three respective frequencies (f₁, f₂, and f₃), with respect to a particular sensor element. It then maps these three phase measurements to a distance associated with the three phase measurements. In one implementation, the depth-computing component 144 can perform this task by using a predetermined lookup table 402. The lookup table 402 maps a combination of phases to a single distance associated with those phases. Or the lookup table 402 maps a combination of phases to intermediary information (such as a combination of wrap integers), from which the depth-computing component 144 can then calculate a single distance. Alternatively, or in addition, the depth-computing component 144 can use a statistical technique (such as a Maximum Likelihood Estimation technique) or a machine-learned statistical model to map a combination of phases to a single distance.

In other cases, the depth-computing component 144 maps the phase measurements to an output conclusion that indicates that the combination of phase measurements does not correspond to any viable distance. This conclusion, in turn, indicates that, due to one or more factors (such as motion blur), the underlying sensor readings that contribute to the phase measurements are corrupted, and thus unreliable.

Although not shown, in some implementations, the conversion component 140 can generate additional information based on the sensor images and/or other collected data. For example, the conversion component 140 can generate a reflectivity image that provides information regarding the reflectivity characteristics of each imaged point in the scene. The conversion component 140 can also generate a confidence image which provides information regarding a level of confidence associated with the computations that are performed with respect to each point in the scene.

In conclusion to Subsection A.1, note that FIG. 1 shows an implementation in which certain operations are allocated to the sensor 112 and other operations are allocated to the depth-generating engine 126. Other implementations of the depth camera system 104 can allocate operations in a different manner than described above. For example, in another implementation, one or more operations performed by the conversion component 140 can be performed by the sensor 112, rather than, or in addition to, the depth-generating engine 126.

A.2. The Calibration System

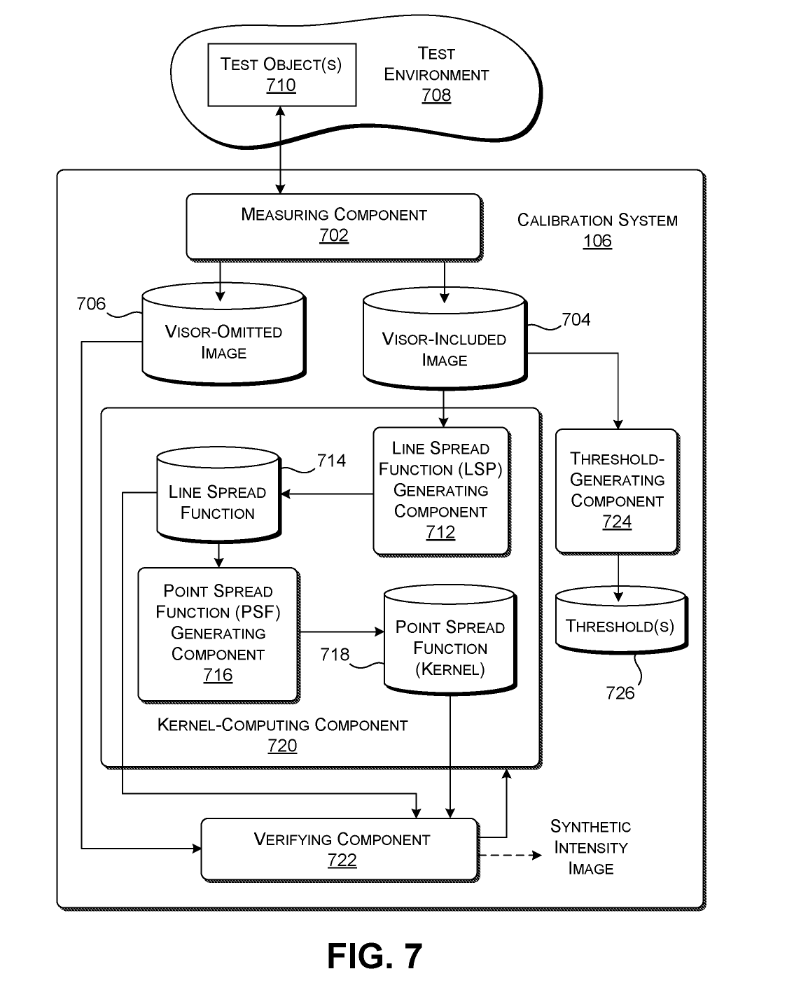

FIG. 7 shows one implementation of the calibration system 106. As stated in Subsection A.1, the purpose of the calibration system 106 is to generate the kernel 128. A measuring component 702 generates at least one visor-included image and stores that image in a data store 704. The measuring component 702 produces the visor-included image with the visor element 116 in place. The measuring component 702 can also optionally produce at least one visor-omitted image. The measuring component 702 produces the visor-omitted image with the visor element 116 removed. In other words, when producing the visor-included image, infrared radiation passes through the visor element 116 before it strikes the surface of the sensor 112. When producing the visor-omitted image, infrared radiation does not pass through the visor element 116 on its way to the sensor 112. Again note that the visor element 116 is just one example of an optical element (OE). In more general terms, the measuring component 702 performs the task of generated an OE-included image (in which the optical element is included) and an OE-omitted image (in which the optical element is omitted).

The visor-included image and the visor-omitted image generally describe the intensity of radiation that is reflected from a test environment 708. The test environment 708 can include one or more test objects 710 (referred to in the singular below). For instance, the test environment 708 can include one or more objects having high reflectivity characteristics set against a dark (e.g., low-intensity)

### BACKGROUND

In one implementation, the measurement component 702 produces each image by producing an active brightness (AB) image based on three instances of raw sensor images, in the manner explained above. In another implementation, the measuring component 702 produces each image in a flashlight mode by irradiating the environment 708 with infrared radiation, and then using the sensor 112 to detect the return-path radiation that is reflected from the environment 708 (and by suitably discounting ambient radiation). The flashlight mode does not take into consideration time-of-flight information. Therefore, any subsequent reference to an image produced by the measuring component 702 can refer to either an AB image or a flashlight-mode image, or any other image that measures the intensity of radiation reflected from the environment 708.

To facilitate explanation, assume that the measuring component 702 produces (and subsequently analyzes) a single visor-included image and a single visor-omitted image. But in other implementations, the measuring component 702 can generate and analyze plural visor-included images and plural visor-omitted images.

In one implementation, the measuring component 702 produces the visor-included image and the visor-omitted image using the same depth camera system 104 described above, with and without the visor element 116, respectively. In another implementation, the measuring component 702 uses a test imaging system that includes the same imaging assembly 114 as the depth camera system 104 (with and without the visor element 116), but otherwise differs in one or more respects from the depth camera system 104. In other words, since the purpose of the calibration system 106 is to generate a kernel 128 that characterizes the imaging assembly 114, the test imaging system should include the same imaging assembly 114 that is used by the depth camera system 104, but can otherwise differ from the depth camera system 104 used in the runtime phase.

A line spread function-generating component 712 generates a line spread function (LSF), and stores the LSF in a data store 714. This LSF is also referred to below as the visor-included LSF. The LSF-generating component 712 performs this task by modeling the blur that occurs in the visor-included image near the edge of a test object. The LSF models the blur as a line because it determines the blur that extends from the edge of the test object along a linear path (described in detail below).

A point spread function-generating component 716 generates a point spread function (PSF) based on the LSF, and stores the PSF in a data store 718. The PSF generally measures the manner in which the imaging assembly 114 disperses radiation originating from a single point of illumination in a scene. As will be described in greater detail below, the PSF-generating component 716 generates the PSF by fitting a rational model (or any other type of model) to the LSF. The kernel 128 corresponds to a discretized version of the PSF.

More specifically, the kernel 128 models the blur caused by all optical elements associated with the imaging assembly 114, including the visor element 116, any lens(es) used by the imaging assembly 114, etc. However, the visor element 116 is the main source of blur, so the kernel 128 can be said to principally model the blur caused by the visor element 116. In other cases, the calibration system 106 can produce a kernel that specifically models the effect of each optical element of the imaging assembly 114. In the runtime phase, the blur-mitigating component 142 can then apply all of the kernels to the sensor images. For instance, the calibration system 106 can produce a kernel that measures just the effect of the visor element 116 by modeling the distortion in the visor-omitted image, and subtracting or otherwise taking account of that effect in the visor-included image.

Collectively, the LSF-generating component 712, the data store 714, the PSF-generating component 716, and the data store 718 correspond to a kernel-computing component 720. The kernel-computing component 720 stores the kernel 128 that it produces in a data store of the blur-mitigating component 142 of the depth camera system 104.

An optional verifying component 722 convolves the visor-omitted image with the kernel 128 to produce a synthetic image. Since the kernel 128 models the blur of the imaging assembly 114, the convolution of the non-visor image with the kernel 128 has the effect of simulating the blur that would be principally caused by the visor element 116. The verifying component 722 then computes a line spread function (LSF) of the synthetic image. The verifying component 722 can then compare the visor-included LSF (in the data store 714) with the synthetic LSF (computed by the verifying component 722). This provides an indication of how well the kernel 128 models the blurring effects of the visor element 116.

Assume that the verifying component 722 reveals that the synthetic LSF is not a sufficiently good match of visor-included LSF, with respect to any measure of line similarity (such as a measure of point-by-point difference between the two LSFs). In response, the verifying component 722 can change one or more operating parameters of the calibration system 106 and regenerate the visor-included LSF. For instance, the verifying component 722 can instruct the calibration system 106 to regenerate the visor-included LSF based on a different sample of blur in the visor-included image, or based on additional samples of blur. Or the verifying component 722 can instruct the measuring component 702 to generate an entirely new visor-included image.

Alternatively, or in addition, the verifying component 722 can generate a synthetic PSF. It can then compare the synthetic PSF with the visor-included PSF stored in the data store 718.

A threshold-generating component 724 can perform analysis to determine the characteristics of a visor-included image that are correlated with the appearance of blur in the visor-included image. For example, the threshold-generating component 724 can determine portions of the visor-included image that suffer from a prescribed amount of blur (which, in turn, can be gauged by determining an LSF for each portion). Assume that each such manifestation of blur occurs in prescribed proximity to some bright test object. The threshold-generating component 724 can then identify the intensity level of each such test object within the visor-included image. This ultimately yields insight into the correlation between intensity levels and the occurrence of blur in the visor-included image, which can be expressed as a threshold value (there being a prescribed likelihood of blur above that threshold). The threshold-generating component 724 can perform the same analysis to identify the intensity level of each low-contrast area next to a bright object. This yields insight into the correlation between large differentials in neighboring intensity levels and the occurrence of blur in the visor-included image, which can be expressed as an upper threshold value and a lower threshold value. Generally, the term “prescribed” value as used herein refers to a value that is chosen based on any environment-specific consideration(s), and which may differ from environment to environment.

The threshold-generating component 724 stores such the threshold value(s) in a data store 726. The blur-mitigating component 142 leverages these threshold value(s) at runtime to select a sub-region to which deconvolution will be applied. In another implementation, the threshold level(s) in the data store 726 are fixed, and not dynamically determined in the calibration phase.

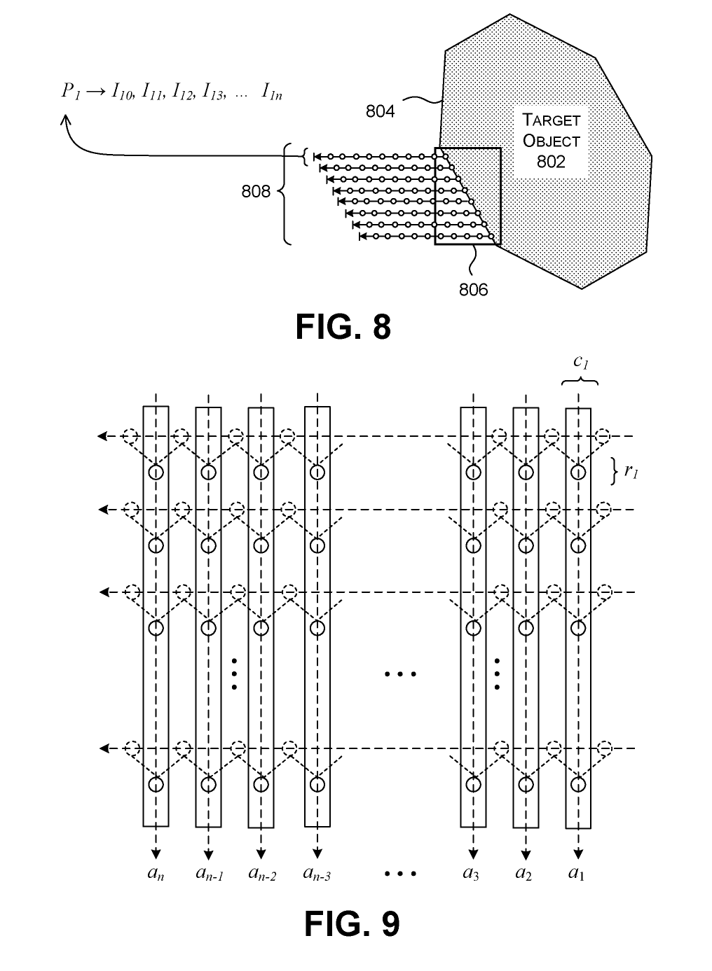

FIGS. 8 and 9 provide further details regarding one manner of operation of the LSF-generating component 712. Beginning with FIG. 8, the LSF-generating component 712 first identifies a test object 802 in the visor-included image that satisfies prescribed criteria. For example, the LSF-generating component 712 can select an object that has an average intensity level above a prescribed threshold value, set against a background having an average intensity level below a prescribed threshold.

The LSF-generating component 712 can then identify a sample edge 804 of the test object 802. It can perform this task by determining a series of pixels at which there is a transition from a high-intensity value to a low-intensity value, and then fitting a line to those pixels. The LSF-generating component 712 can then choose a sample region 806 that encompasses a predetermined number of pixels that lie on the edge 804 of the test object 802.

The LSF-generating component 712 then models the blur that occurs at the edge 804. It does this by identifying a plurality of rows 808 of pixels, where each row of pixels extends outward from the edge 804 in a same direction, such as along an x axis from right to left. Each row of pixels includes a predetermined number (h) of pixels, such as 25 pixels. The LSF-generating component 712 then stores the intensity value of each pixel in each row. For example, consider a pixel P₁ that lies on the edge 804. A series of pixels (P₁₁, P₁₂, . . . , P₁ₙ) extend leftward from this pixel P₁. The LSF-generating component stores the intensity values associated with each of these pixels, e.g., (I₁₁, I₁₂, . . . , I₁ₙ).

Advancing to FIG. 9, the LSF-generating component 712 next takes the differential of each row of pixels. For example, the LSF-generating component 712 can generate a difference value within a row of pixels by subtracting an intensity value of a pixel at position (x[i+1], y) from an intensity value of a pixel at position (x[i], y). This operation collectively generates a plurality of rows of difference values, such as illustrative row r₁. It also yields a plurality of columns of difference values, such as illustrative column c₁. Next, the LSF-generating component 712 takes the average of the difference values in each column. For example, the average of column c₁ is a₁. The average values (a₁, a₂, . . . , aₙ) collectively form the LSF, e.g., y=LSF (x), where y is an average value, and x is a pixel position value with respect to the edge. In another implementation, the LSF-generating component 712 can perform a smoothing operation (e.g., Gaussian smoothing operation) on the difference values in the columns prior to generating the average value. Or the LSF-generating component 712 can perform a smoothing operation on the average values themselves.

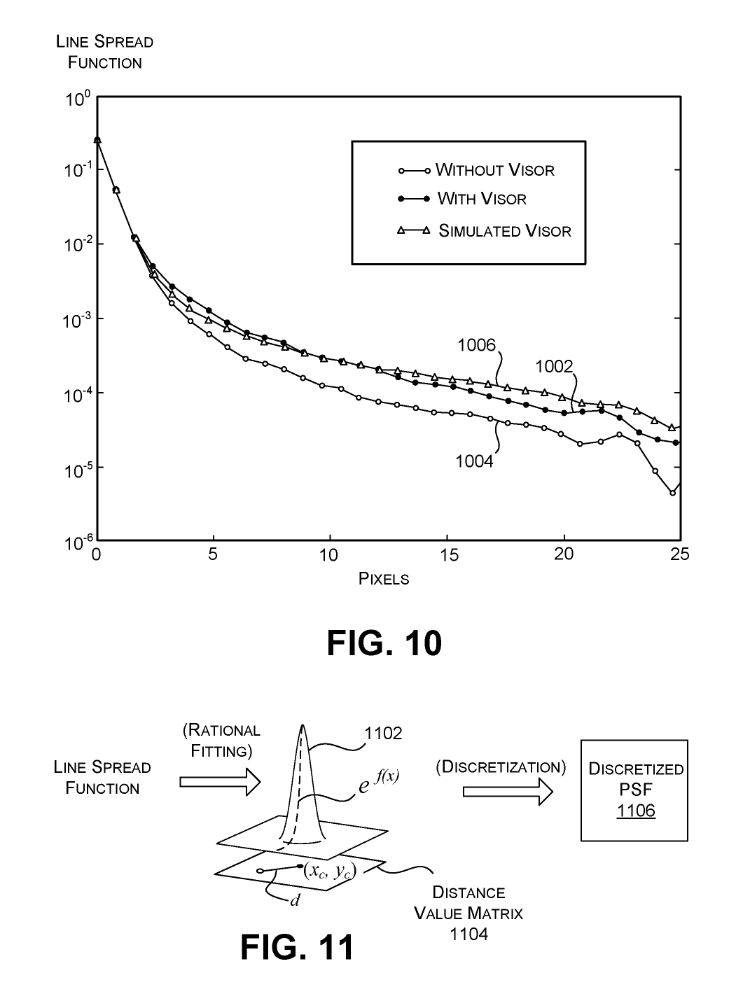

FIG. 10 shows three line spread functions (LSFs) that are generated by the calibration system 106. More specifically, the horizontal axis of the graph shown in FIG. 10 represents the number of pixels x that extend out from the edge 804 in the leftward direction. Without limitation, the 25^{th} pixel (x=25) represents the pixel that is farthest from the edge 804. The vertical axis of the graph corresponds to y′=log(y), where y, in turn, corresponds to LSF(x). In other words, the vertical-axis value on any curve corresponds to the log of an average value computed in FIG. 9.

A first curve 1002 shows the LSF that is computed based on the visor-included image. A second curve 1004 shows the LSF that is computed based on the visor-omitted image. A third curve 1006 shows the LSF that is computed based on the optional synthetic image (produced at the direction of the verifying component 722). Note that the third curve 1006 closely tracks the first curve 1002, indicating that the kernel 128 does an adequate job of modeling the blur caused by the visor element 116.

Note that the second curve 1004, produced based on the visor-omitted image, indicates that some blur is occurring due to factors other than the visor element 116. For instance, that blur may originate from one or more lenses used by the imaging assembly 114. A defect-free LSF (not shown) would correspond to a step function, indicating that no distortion occurs outside the edge of the bright test object 802.

FIG. 11 shows one manner of operation of the PSF-generating component 716. The PSF-generating component 716 first fits a model to the discrete data points associated with y′, as a function of x. For example, without limitation, the PSF-generating component 716 can fit a rational model of the following form that describes the relationship of y′ to the pixel position x:

$$f ( x ) = \frac{{p}_{1} {x}^{3} + {p}_{2} {x}^{2} + {p}_{3} x + {p}_{4}}{{x}^{3} + {w}_{1} {x}^{2} + {w}_{2} x + {w}_{3}} . \qquad ( 5 )$$

The symbols p₁, p₂, p₃, p₄, w₁, w₂, and w₃ represent constant values determined by the fitting procedure. The PSF itself correspond to:

PSF(x)=e^{f(x)} (6).

The PSF defines the surface of a three-dimension function 1102, e.g., which can be visualized as a non-linear cone-shaped function that would be produced by sweeping Equation (6) around a pivot point (corresponding to a highest value of the three-dimensional function).

Next, the PSF-generating component 716 generates an n×n distance value matrix 1104. Each element of the distance value matrix 1104 specifies a Euclidean distance from a center point of the distance value matrix 1104. That is, if the center of the distance value matrix has a position (x_{c}, y_{c}), then the value of each element in the distance value matrix 1104 is given by the following formula:

d=\sqrt{(x−x_{c})²+(y−y_{c})²} (7).

Finally, the PSF-generating component 716 computes an n×n kernel 1106 by computing PSF(d)=e^{f(d)} for each value of d in the distance value matrix 1104, where f(d) is given by the Equations (5) and (6) (and by replacing x with d).

A.3. The Blur-Mitigating Component

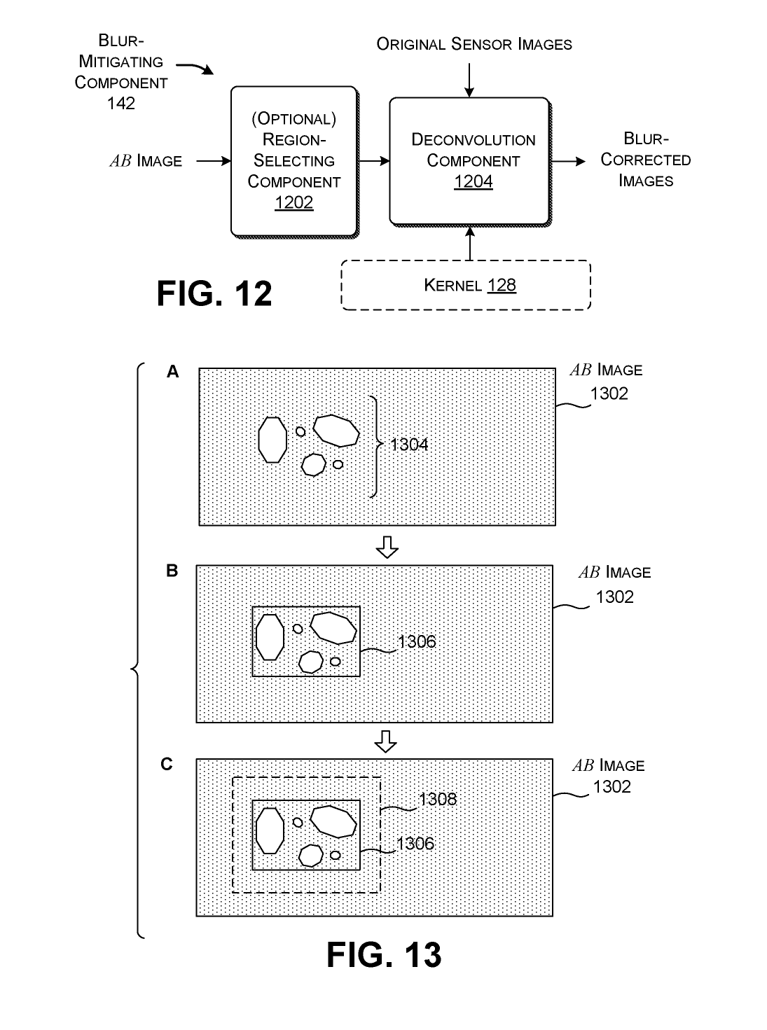

FIG. 12 shows one implementation of the blur-mitigating component 142 introduced in Subsection A.1. The blur-mitigating component 142 applies the kernel 128 computed by the calibration system 106 to the sensor images produced by the sensor 112.

An optional region-selecting component 1202 determines a sub-region (if any) within a sensor image within which to apply the kernel 128. In one implementation, the region-selecting component 1202 performs this task by analyzing the intensity values in an active brightness (AB) image. For instance, consider an active-brightness image that is computed for a given frequency fₖ, based on three sensor images associated with three respective phases. The region-selecting component 1202 can identify one or more sub-regions (if any) in that AB image, and then perform deconvolution within corresponding sub-regions of each of the three sensor images. For example, assume that the region-selecting component 1202 identifies a rectangular sub-region in the AB image defined by four (x, y) positions; the region-selecting component 1202 applies the kernel 128 to a sub-region in the sensor images defined by same four positions. In another implementation, the region-selecting component 1202 uses some other image that captures the brightness of objects in a scene to identify the sub-region(s), rather than an AB image. In yet another implementation, the blur-mitigating component 142 can eliminate the use of the region-selecting component 1202, in which case it applies the kernel 128 to the entirety of each sensor image.

When used, the region-selecting component 1202 can operate in different ways. In one approach, the region-selecting component 1202 can identify all active brightness values in the AB image above a prescribed threshold. The region-selecting component 1202 can then draw a rectangular box (or any other shape) which encompasses all of those active brightness values. The region-selecting component 1202 can implement this approach by creating a mask that includes a 1-value for every pixel that meets the above-described criterion, and a 0-value for every pixel that does not meet the criterion. The region-selecting component 1202 then draws a border that encompasses all of the 1-values in the mask.

In another approach, the region-selecting component 1202 can use a clustering technique to group together spatially proximate active brightness values above a prescribed threshold. The region-selecting component 1202 can then draw boxes (or other shapes) around the clusters.

In another approach, the region-selecting component 1202 can determine all absolute brightness values in the AB image that are above a prescribed threshold, and which have one or more neighboring absolute brightness values below a prescribed threshold. The region-selecting component 1202 can then draw a box (or other shape) around the qualifying absolute brightness values. This approach finds objects that are bright and also stand out against a relatively dark background.

In one implementation, the various threshold values mentioned above can be generated in the calibration phase by the threshold-generating component 724. As explained in Subsection A.2, for instance, the threshold-generating component 724 can generate one or more threshold values based on a calibration-phase analysis of the correlation between brightness level and blur in the visor-included image.

The region-selecting component 1202 can use yet other techniques to find qualifying sub-regions, including pattern-matching techniques, machine-learned model techniques, etc. The region-selecting component 1202 can also use various implementation-specific rules. For example, the region-selecting component 1202 can identify whether a bright pixel in an AB image (having an intensity value above a prescribed threshold value) is part of a bright object that is larger than a prescribed size, or whether the bright pixel corresponds to an isolated artifact that is not part of a larger object. The region-selecting component 1202 can use this information to determine how it defines the perimeter of the sub-region, and how it classifies the nature of the sub-region.

The region-selecting component 1202 can perform a final operation of expanding the spatial scope of each sub-region that it identifies. For example, assume that the region-selecting component 1202 identifies an initial sub-region having a perimeter which encompasses all the active brightness values above a prescribed threshold. That perimeter may lie very close to some of those active brightness values in the AB image. The region-selecting component 1202 expands the perimeter away from these active brightness values, thus extending the size of the sub-region as a whole. The region-selecting component 1202 performs this operation because the blur often extends many pixels beyond the edge of a bright object; the region-selecting component 1202 expands the perimeter to make sure deconvolution is performed for those pixels near an edge that are likely to suffer from blur. In one implementation, the region-selecting component 1202 expands the perimeter of a rectangular sub-region by a distance that is one-half the size of the kernel 128; for a rectangular perimeter with sides parallel to the x and y axes, it can make such an extension in the positive x direction, the negative x direction, the positive y direction, and the negative y direction.

FIG. 13 shows an example of the operation of the region-selecting component 1202. In stage A, the region-selecting component 1202 receives an AB image 1302 having a group of bright objects 1304 set against a low-intensity background. In stage B, the region-selecting component 1202 identifies the objects 1304 using any test described above. It also draws a box 1306 around the objects 1304. In stage C, the region-selecting component 1202 expands the size of the sub-region to a new perimeter 1308.

Returning to FIG. 12, a deconvolution component 1204 performs the actual deconvolution operation on the original sensor images. The deconvolution component 1204 can use any deconvolution technique to perform this operation, including, but not limited to: Richardson-Lucy deconvolution, any Fourier Transform-based deconvolution, etc. From a high-level standpoint, the convolution of a clean signal b with a kernel v yields a recorded noisy signal h; in other words, b*v=h. In a Fourier-based approach, the deconvolution component 1204 recovers the clean signal b by taking the Fourier transform of h (which yields H), taking the Fourier Transform of v (which yields V), dividing H by V to get B, and then forming the inverse Fourier Transform of B to get the clean signal b. In the Richard-Lucy deconvolution, the deconvolution component 1204 iteratively computes the clean signal b, e.g., using an expectation-maximization technique.

The deconvolution component 1204 performs the deconvolution operation on a pixel-by-pixel basis, for each pixel inside the sub-region chosen by the region-selecting component 1202 (wherein that sub-region has been suitably expanded in the manner described above). In the process of correcting any single pixel (referred to as a “pixel-under-consideration”), the deconvolution component 1204 takes into consideration the contribution of a set of pixels that neighbor the pixel-under-consideration (as specified by the kernel 128), but only changes the value of the pixel-under-consideration.

In conclusion to Section A, note that the system 102 of FIG. 1 can be varied and/or extended in various ways. For example, in the above explanation, the kernel-computing component 720 of the calibration system 106 computes a single kernel 128 based on a single LSF. In other cases, the kernel-computing component 720 can compute plural kernels based on different respective capture scenarios. For example, the kernel-computing component 720 can compute plural kernels for different ranges of depths at which a test object may appear in a scene. In the runtime phase, the blur-mitigating component 142 can then select an appropriate kernel to apply to a sensor image based on the depth of each object captured by that sensor image. To perform this task, the blur-mitigating component 142 can rely on the depth-computing component 144 to generate provisional depth values for the objects in a scene.

In another variation, other types of depth camera systems compared to those described above can use the blur-reduction techniques described above. For example, another type of time-of-flight depth camera system (besides a phase-based ToF depth camera system) can use the blur-reduction techniques. In another case, a structured light depth camera system or a stereoscopic depth camera system can use the blur-reduction techniques.

B. Illustrative Head-Mounted Display

FIG. 11 shows a head mounted display (HMD) 1402 that incorporates the depth camera system 104 described in Section A. The HMD 1402 can provide a mixed-reality experience (also referred to as an augmented-reality experience) or an entirely virtual experience.

The HMD 1402 includes a collection of input systems 1404 for interacting with a physical environment 1406. The input systems 1404 can include, but are not limited to: one or more environment-facing video cameras, an environment-facing depth camera system, a gaze-tracking system, an inertial measurement unit (IMU), one or more microphones, etc. Each video camera may produce red-green-blue (RGB) image information and/or monochrome grayscale information. The depth camera system corresponds to the depth camera system 104 shown in FIG. 1, which includes the visor element 116.

In one implementation, the IMU can determine the movement of the HMD 1402 in six degrees of freedom. The IMU can include one or more accelerometers, one or more gyroscopes, one or more magnetometers, etc. In addition, the input systems 1404 can incorporate other position-determining mechanisms for determining the position of the HMD 1402, such as a global positioning system (GPS) system, a beacon-sensing system, a wireless triangulation system, a dead-reckoning system, a near-field-communication (NFC) system, etc., or any combination thereof.

The gaze-tracking system can determine the position of the user's eyes and/or head. The gaze-tracking system can determine the position of the user's eyes, by projecting light onto the user's eyes, and measuring the resultant glints that are reflected from the user's eyes. Illustrative information regarding the general topic of eye-tracking can be found, for instance, in U.S. Patent Application No. 20140375789 to Lou, et al., published on Dec. 25, 2014, entitled “Eye-Tracking System for Head-Mounted Display.” The gaze-tracking system can determine the position of the user's head based on IMU information supplied by the IMU.

A command processing engine 1408 performs any type of processing on the raw input signals fed to it by the input systems 1404. For example, the command processing engine 1408 can identify an object that the user is presumed to be looking at in the modified-reality environment by interpreting input signals supplied by the gaze-tracking system. The command processing engine 1408 can also identify any bodily gesture performed by the user by interpreting inputs signals supplied by the video camera(s) and/or depth camera system, etc.

In some implementations, a tracking component 1410 may create a map of the physical environment 1406, and then leverage the map to determine the location of the HID 1402 in the physical environment 1406. A data store 1412 stores the map, which also constitutes world information that describes at least part of the modified-reality environment. The tracking component 1410 can perform the above-stated tasks using Simultaneous Localization and Mapping (SLAM) technology. In one implementation, the SLAM technology leverages image information provided by the video camera(s) and/or the depth camera system, together with IMU information provided by the IMU. Background information regarding the general topic of SLAM can be found in various sources, such as Durrant-Whyte, et al., “Simultaneous Localisation and Mapping (SLAM): Part I The Essential Algorithms,” in IEEE Robotics & Automation Magazine, Vol. 13, No. 2, July 2006, pp. 99-110, and Bailey, et al., “Simultaneous Localization and Mapping (SLAM): Part II,” in IEEE Robotics & Automation Magazine, Vol. 13, No. 3, September 2006, pp. 108-117.

Alternatively, the HID 1402 can receive a predetermined map of the physical environment 1406, without the need to perform the above-described SLAM map-building task.

A surface reconstruction component 1414 identifies surfaces in the modified-reality environment based on image information provided by the video cameras, and/or the depth camera system, and/or the map provided by the tracking component 1410. The surface reconstruction component 1414 can then add information regarding the identified surfaces to the world information provided in the data store 1412.

In one approach, the surface reconstruction component 1414 can identify principal surfaces in a scene by analyzing a 2D depth image captured by the depth camera system at a current time, relative to the current location of the user. For instance, the surface reconstruction component 1414 can determine that a given depth value is connected to a neighboring depth value (and therefore likely part of a same surface) when the given depth value is no more than a prescribed distance from the neighboring depth value. Using this test, the surface reconstruction component 1414 can distinguish a foreground surface from a background surface. The surface reconstruction component 1414 can improve its analysis of any single depth image using any machine-trained pattern-matching model and/or image segmentation algorithm. The surface reconstruction component 1414 can also use any least-squares-fitting techniques, polynomial-fitting techniques, patch-assembling techniques, etc. Alternatively, or in addition, the surface reconstruction component 1414 can use known fusion techniques to reconstruct the three-dimensional shapes of objects in a scene by fusing together knowledge provided by plural depth images.

Illustrative information regarding the general topic of surface reconstruction can be found in: U.S. Patent Application No. 20110109617 to Snook, et al., published on May 12, 2011, entitled “Visualizing Depth”; U.S. Patent Application No. 20150145985 to Gourlay, et al., published on May 28, 2015, entitled “Large-Scale Surface Reconstruction that is Robust Against Tracking and Mapping Errors”; U.S. Patent Application No. 20130106852 to Woodhouse, et al., published on May 2, 2013, entitled “Mesh Generation from Depth Images”; U.S. Patent Application No. 20150228114 to Shapira, et al., published on Aug. 13, 2015, entitled “Contour Completion for Augmenting Surface Reconstructions”; U.S. Patent Application No. 20160027217 to da Veiga, et al., published on Jan. 28, 2016, entitled “Use of Surface Reconstruction Data to Identity Real World Floor”; and U.S. Patent Application No. 20160364907 to Schoenberg, published on Dec. 15, 2016, entitled “Selective Surface Mesh Regeneration for 3-Dimensional Renderings.”

A scene presentation component 1416 can use known graphics pipeline technology to produce a three-dimensional (or two-dimensional) representation of the modified-reality environment. The scene presentation component 1416 generates the representation based at least on virtual content provided by an invoked application, together with the world information in the data store 1412. The graphics pipeline technology can include vertex processing, texture processing, object clipping processing, lighting processing, rasterization, etc. Overall, the graphics pipeline technology can represent surfaces in a scene using meshes of connected triangles or other geometric primitives. When used in conjunction with an HMD, the scene processing component 1416 can also produce images for presentation to the left and rights eyes of the user, to produce the illusion of depth based on the principle of stereopsis.

One or more output devices 1418 provide a representation of the modified-reality environment 1420. The output devices 1418 can include any combination of display devices, including a liquid crystal display panel, an organic light emitting diode panel (OLED), a digital light projector, etc. In one implementation, the output devices 1418 can include a semi-transparent display mechanism. That mechanism provides a display surface on which virtual objects may be presented, while simultaneously allowing the user to view the physical environment 1406 “behind” the display device. The user perceives the virtual objects as being overlaid on the physical environment 1406 and integrated with the physical environment 1406. In another implementation, the output devices 1418 include an opaque (non-see-through) display mechanism for providing a fully immersive virtual display experience.

The output devices 1418 may also include one or more speakers. The speakers can provide known techniques (e.g., using a head-related transfer function (HRTF)) to provide directional sound information, which the user perceives as originating from a particular location within the physical environment 1406.

The HMD 1402 can include a collection of local applications 1422, stored in a local data store. Each local application can perform any function. A communication component 1424 allows the HMD 1402 to interact with remote resources 1426. Generally, the remote resources 1426 can correspond to one or more remote computer servers, and/or one or more user devices (e.g., one or more remote HMDs operated by other users), and/or other kind(s) of computing devices. The HMD 1402 may interact with the remote resources 1426 via a computer network 1428. The computer network 1428, in turn, can correspond to a local area network, a wide area network (e.g., the Internet), one or more point-to-point links, etc., or any combination thereof. The communication component 1424 itself may correspond to a network card or other suitable communication interface mechanism.

In one case, the HMD 1402 can access remote computing logic to perform any function(s) described above as being performed by the HMD 1402. For example, the HMD 1402 can offload the task of building a map and/or reconstructing a surface (described above as being performed by the tracking component 1410 and surface reconstruction component 1414, respectively) to the remote computing logic. In another case, the HMD 1402 can access a remote computer server to download a new application, or to interact with a remote application (without necessarily downloading it).

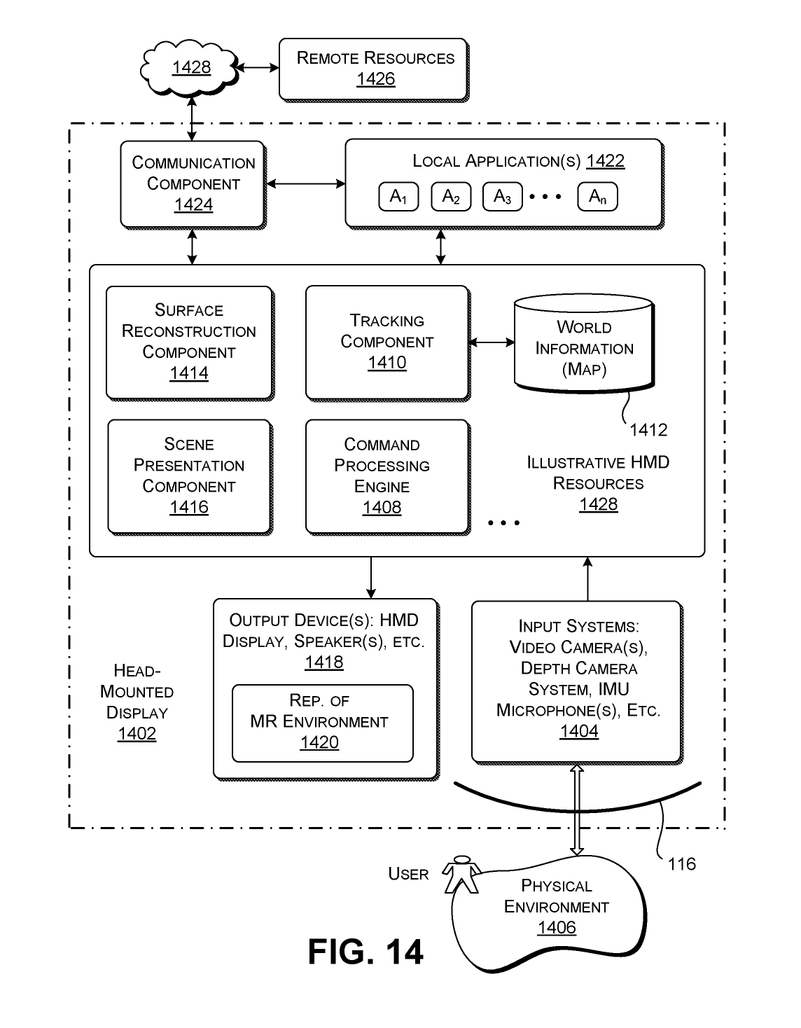

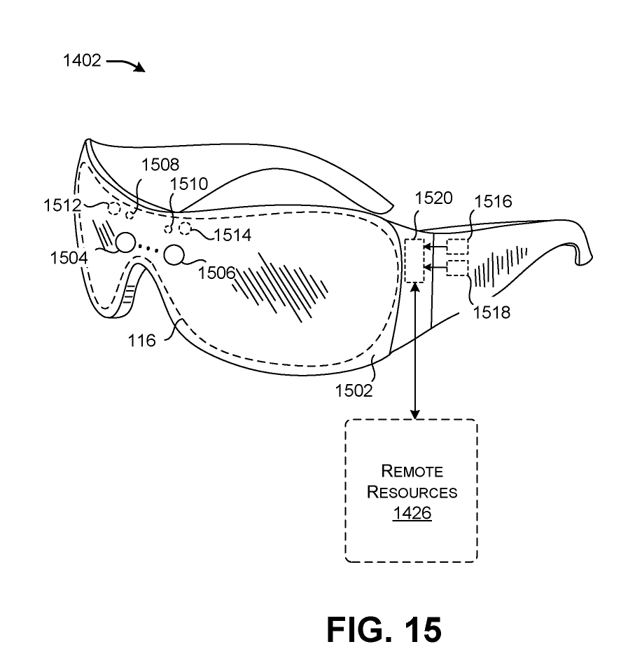

FIG. 15 shows illustrative and non-limiting structural aspects of the HMD 1402 shown in FIG. 14. The HMD 1402 includes a head-worn frame that houses or otherwise affixes a see-through display device 1502 or an opaque (non-see-through) display device. Waveguides (not shown) or other image information conduits direct left-eye images to the left eye of the user and direct right-eye images to the right eye of the user, to overall create the illusion of depth through the effect of stereopsis. Although not shown, the HMD 1402 can also include speakers for delivering sounds to the ears of the user.

The HMD 1402 can include any environment-facing imaging components, such as representative environment-facing imaging components 1504 and 1506. The imaging components (1504, 1506) can include RGB cameras, monochrome cameras, a depth camera system (including an illumination source and a sensor), etc. While FIG. 15 shows only two imaging components (1504, 1506), the HMD 1402 can include any number of such components. The imaging components (1504, 1506) send and/or receive radiation through a visor element 116. In other cases, the visor element 116 just covers the imaging components (1504, 1506), rather than extending over the entire face of the HMD 1402 as shown in FIG. 15.

The HMD 1402 can include an inward-facing gaze-tracking system. For example, the inward-facing gaze-tracking system can include light sources (1508, 1510) for directing light onto the eyes of the user, and cameras (1512, 1514) for detecting the light reflected from the eyes of the user.

The HMD 1402 can also include other input mechanisms, such as one or more microphones 1516, an inertial measurement unit (IMU) 1518, etc. As explained above, the IMU 1518 can include one or more accelerometers, one or more gyroscopes, one or more magnetometers, etc., or any combination thereof.

A controller 1520 can include logic for performing any of the tasks described above in FIG. 14. The controller 1520 may optionally interact with the remote resources 1426 via the communication component 1424 (shown in FIG. 14).

C. Illustrative Processes

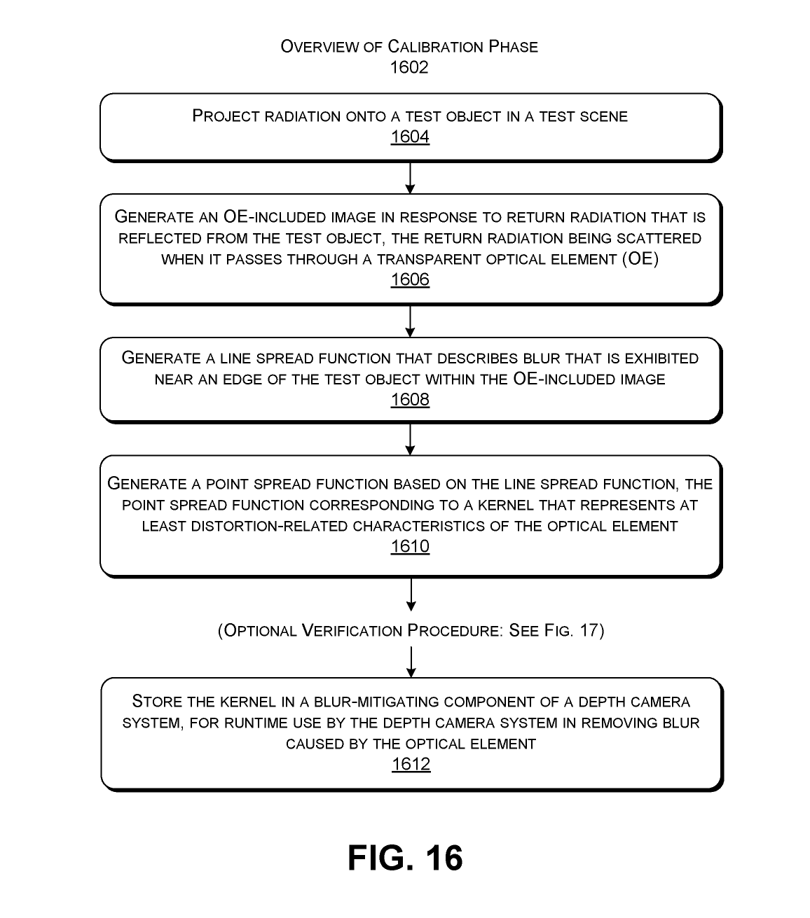

FIGS. 16-19 show processes that explain the operation of the system 102 of Section A in flowchart form. Since the principles underlying the operation of the system 102 have already been described above, certain operations will be addressed in summary fashion in this section. As noted in the prefatory part of the Detailed Description, each flowchart is expressed as a series of operations performed in a particular order. But the order of these operations is merely representative and can be varied in any manner.

FIG. 16 shows a process 1602 that describes an overview of one manner of operation of the calibration system 106 of FIG. 4 (in a calibration phase). In block 1604, the calibration system 106 projects radiation onto a test object 710 in a test scene. In block 1606, the calibration system 106 generates an OE-included image in response to return radiation that is reflected from the test object 710, the return radiation being scattered when it passes through a transparent optical element (OE), one example of which corresponds to the transparent visor element 116. In block 1608, the calibration system 106 generates a line spread function (LSF) that describes blur that is exhibited near an edge of the test object 710 within the OE-included image. In block 1610, the calibration system 106 generates a point spread function (PSF) based on the LSF, the point spread function corresponding to a kernel 128 that represents at least characteristics of the optical element. At this juncture, the calibration system 106 can optionally perform a verification procedure described below in FIG. 15. In block 1612, the calibration system 106 stores the kernel 128 in the blur-mitigating component 142 of the depth camera system 104, for runtime use by the depth camera system 104 in removing blur caused by the visor element 116.

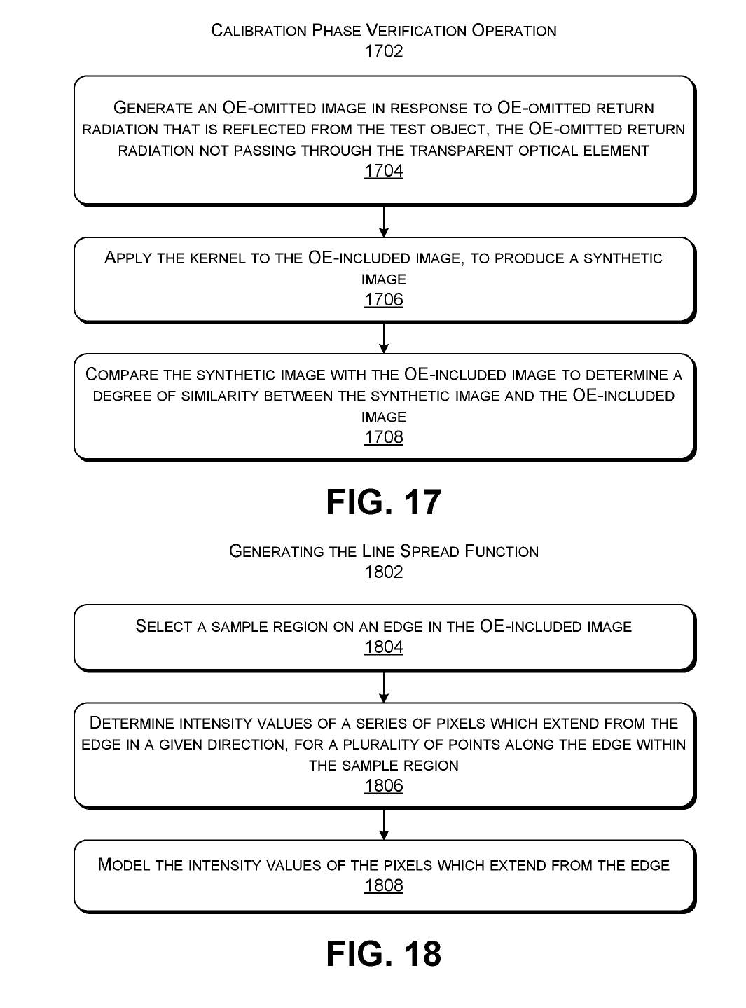

FIG. 17 shows a process 1702 that describes a verification operation performed in the calibration phase by the calibration system 106. In block 1704, the calibration system 106 generates an OE-omitted image in response to OE-omitted return radiation that is reflected from the test object 710, the OE-omitted return radiation not passing through the optical element (e.g., not passing through the transparent visor element 116). In block 1706, the calibration system 106 applies the kernel 128 to the OE-omitted image, to produce a synthetic image. In block 1708, the calibration system 106 compares the synthetic image with the OE-included image to determine a degree of similarity between the synthetic image and the OE-included image.

FIG. 18 shows a process 1802 that describes one way to generate the LSF in the calibration phase. In block 1804, the calibration system 106 selects a sample region on an edge of the test object 710 in the OE-included image. In block 1806, the calibration system 106 determines intensity values of a series of pixels which extend from the edge in a given direction, for a plurality of points along the edge within the sample region. In block 1808, the calibration system 106 models the intensity values of the pixels which extend from the edge.

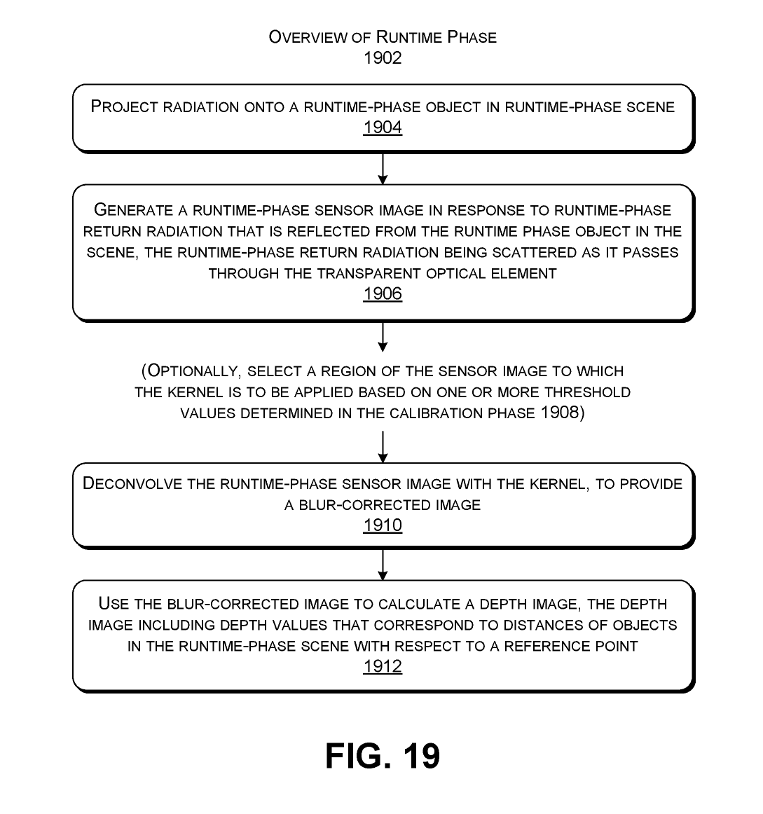

FIG. 19 shows a process 1902 that describes an overview of one manner of operation of the depth camera system 104 of FIG. 1 in a runtime phase. In block 1904, the depth camera system 104 projects radiation onto a runtime-phase object in a runtime-phase scene. In block 1906, the depth camera system 104 generates a runtime-phase sensor image in response to runtime-phase return radiation that is reflected from the runtime-phase object in a scene, the runtime-phase return radiation passing through the transparent optical element (e.g., the transparent visor element 116). In optional block 1908, the depth camera system 104 can select a sub-region of the original sensor image to which the kernel 128 is to be applied using one or more threshold values determined in the calibration phase. In block 1910, the depth capture system 104 deconvolves the runtime-phase sensor image with the kernel 128, to provide a blur-reduced image. In block 1912, the depth capture system 104 uses the blur-reduced image to calculate a depth image, the depth image including depth values that reflect distances of objects in the runtime-phase scene with respect to a reference point.

D. Representative Computing Functionality

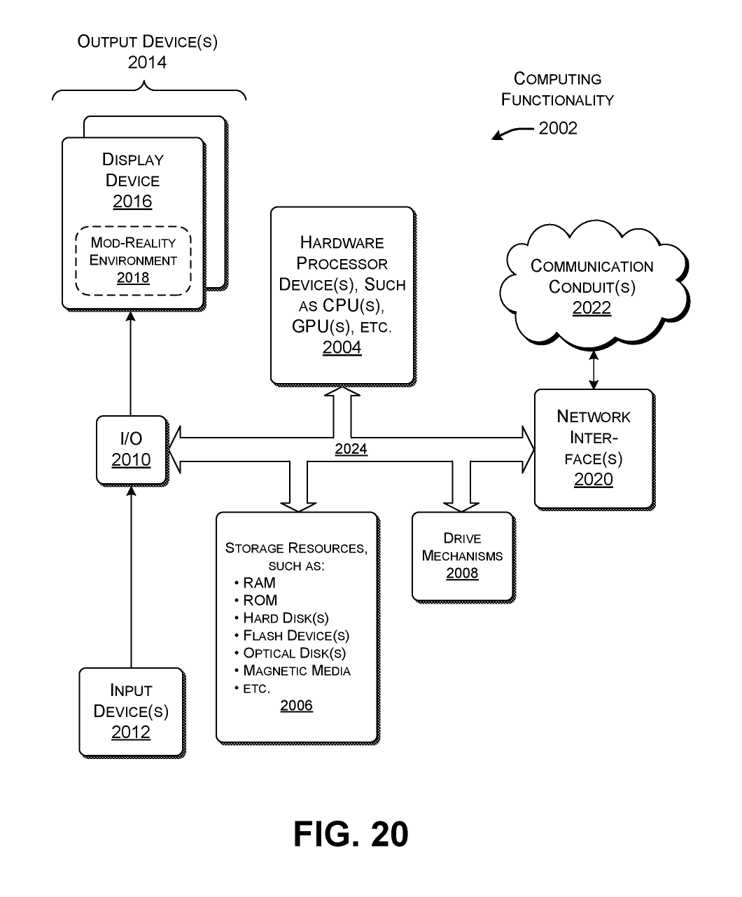

FIG. 20 more generally shows computing functionality 2002 that can be used to implement any aspect of the mechanisms set forth in the above-described figures. For instance, the type of computing functionality 2002 shown in FIG. 20 can be used to implement the depth capture system 104 of FIG. 1, or, more specifically, the HMD 1402 of FIGS. 14 and 15. The computing functionality 2002 can also be used to implement the calibration system 106 of FIG. 1. In all cases, the computing functionality 2002 represents one or more physical and tangible processing mechanisms.

The computing functionality 2002 can include one or more hardware processor devices 2004, such as one or more central processing units (CPUs), and/or one or more graphics processing units (GPUs), and so on. The computing functionality 2002 can also include any storage resources (also referred to as computer-readable storage media or computer-readable storage medium devices) 2006 for storing any kind of information, such as machine-readable instructions, settings, data, etc. Without limitation, for instance, the storage resources 2006 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 2002. The computing functionality 2002 may perform any of the functions described above when the hardware processor device(s) 2004 carry out computer-readable instructions stored in any storage resource or combination of storage resources. For instance, the computing functionality 2002 may carry out computer-readable instructions to perform each block of the processes described in Section C. The computing functionality 2002 also includes one or more drive mechanisms 2008 for interacting with any storage resource, such as a hard disk drive mechanism, an optical disk drive mechanism, and so on.

The computing functionality 2002 also includes an input/output component 2010 for receiving various inputs (via input devices 2012), and for providing various outputs (via output devices 2014). Illustrative input devices and output devices were described above in the context of the explanation of FIG. 14. For instance, the input devices 2012 can include any combination of video cameras, the sensor 112 of the depth camera system 104, microphones, an IMU, etc. The output devices 2014 can include a display device 2016 that presents a modified-reality environment 2018 of any type, speakers, etc. The computing functionality 2002 can also include one or more network interfaces 2020 for exchanging data with other devices via one or more communication conduits 2022. One or more communication buses 2024 communicatively couple the above-described components together.

The communication conduit(s) 2022 can be implemented in any manner, e.g., by a local area computer network, a wide area computer network (e.g., the Internet), point-to-point connections, etc., or any combination thereof. The communication conduit(s) 2022 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 2002 (and its hardware processor(s)) can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc. In this case, the machine-executable instructions are embodied in the hardware logic itself

The following summary provides a non-exhaustive list of illustrative aspects of the technology set forth herein.

According to a first aspect, a depth camera system is described for producing a depth image. The depth camera system includes an imaging assembly configured to produce a sensor image based on return radiation reflected from a scene that has been irradiated by an illumination source. The imaging assembly, in turn, includes: a transparent optical element (OE) through which at least the return radiation passes; and a sensor on which the return radiation impinges after passing through the optical element, and which produces signals in response thereto. The sensor image is formed based on the signals provided by the sensor. The depth camera system also includes a blur-mitigating component configured to deconvolve the sensor image with a kernel, to provide a blur-reduced image, the kernel representing a point spread function that describes distortion-related characteristics of at least the optical element. The depth camera system also includes a depth-computing component configured to use the blur-reduced image to calculate a depth image, the depth image including depth values that reflect distances of objects in the scene with respect to a reference point.

According to a second aspect, the depth camera system is configured to calculate the depth values using a time-of-flight technique.

According to a third aspect, the depth camera system is incorporated as an element in a head-mounted display, and wherein the optical element is a visor element of the head-mounted display.

According to a fourth aspect, the blur-mitigating component is configured to apply the kernel to an entirety of the sensor image.

According to a fifth aspect, the depth camera system further includes a region-selecting component configured to select a sub-region of the sensor image to which the kernel is to be applied.

According to a sixth aspect, the depth camera system is further configured to generate a brightness image based, in part, on the sensor image. Further, the region-selecting component is configured to identify the sub-region of the sensor image by finding a corresponding sub-region in the brightness image having one more or brightness values above a prescribed threshold.

According to a seventh aspect, the region-selecting component is configured to identify the sub-region of sensor image by finding a corresponding sub-region in the brightness image having one more or brightness values above a prescribed threshold, the corresponding sub-region also being in prescribed proximity to a neighboring sub-region in the brightness image having one or more brightness values below another prescribed threshold.

According to an eighth aspect, the region-selecting component is configured to find an initial sub-region that satisfies a region-selection criterion, and then to expand the initial sub-region by a prescribed amount.

According to a ninth aspect, the prescribed amount (recited in the eighth aspect) is determined based on a size of the blur kernel.

According to a tenth aspect, the imaging assembly includes one or more lenses, and wherein the point spread function also describes distortion-related characteristics of the lenses.

According to an eleventh aspect, the point spread function is derived from a line spread function, and wherein the line spread function describes blur that is exhibited near an edge of a test object.

According to a twelfth aspect, a method is described for mitigating image blur. The method includes: projecting radiation onto a test object in a test scene; generating an optical element (OE)-included image in response to return radiation that is reflected from the test object, the return radiation being scattered when it passes through a transparent optical element (OE); generating a line spread function that describes blur that is exhibited near an edge of the test object within the OE-included image; generating a point spread function based on the line spread function, the point spread function corresponding to a kernel that represents distortion-related characteristics of at least the optical element; and storing the kernel in a blur-mitigating component of a depth camera system, for runtime use by the depth camera system in removing blur caused by the optical element.

According to a thirteenth aspect, the method further includes, prior to the storing operation: generating an OE-omitted image in response to OE-omitted return radiation that is reflected from the test object, the OE-omitted return radiation not passing through the transparent optical element; applying the kernel to the OE-omitted image, to produce a synthetic image; and comparing the synthetic image with the OE-included image to determine a degree of similarity between the synthetic image and the OE-included image.

According to a fourteenth aspect, the operation of generating the line spread function includes: selecting a sample region on an edge in the OE-included image; determining intensity values of a series of pixels which extend from a point on the edge in a given direction, for a plurality of points along the edge within the sample region; and modeling the intensity values of the pixels which extend from the edge.

According to a fifteenth aspect, the method further includes, in a runtime phase: projecting radiation onto a runtime-phase object in a runtime-phase scene; generating a runtime-phase sensor image in response to runtime-phase return radiation that is reflected from the runtime-phase object, the runtime-phase return radiation passing through the transparent optical element; deconvolving the runtime-phase sensor image with the kernel, to provide a blur-reduced image; and using the blur-reduced image to calculate a depth image, the depth image including depth values that reflect distances of objects in the runtime-phase scene with respect to a reference point.

According to a sixteenth aspect, the method further includes selecting a sub-region of the runtime-phase sensor image to which the kernel is to be applied based on a threshold value determined in the calibration phase.

According to a seventeenth aspect, a computer-readable storage medium is described for storing computer-readable instructions. The computer-readable instructions, when executed by one or more processor devices, perform a method that includes: receiving a sensor image that is generated in response to return radiation that is reflected from an object in a scene, the return radiation being scattered when it passes through a transparent optical element (OE); deconvolving the sensor image with a kernel, to provide a blur-reduced image, the kernel representing a point spread function that describes distortion-related characteristics of at least the optical element; and using the blur-reduced image to calculate a depth image, the depth image including depth values that reflect distances of objects in the scene with respect to a reference point.

According to an eighteenth aspect, the method (of the seventeenth aspect) further includes selecting a sub-region of the sensor image to which the kernel is to be applied.

According to a nineteenth aspect, the method (of the eighteenth aspect) further includes generating a brightness image based, in part, on the sensor image. The selecting operation further includes identifying the sub-region of the sensor image by finding a corresponding sub-region in the brightness image having one more or brightness values above a prescribed threshold.

According a twentieth aspect, the method (of the eighteenth aspect) further includes generating a brightness image based, in part, on the sensor image. The selecting operation further includes identifying the sub-region of sensor image by finding a corresponding sub-region in the brightness image having one more or brightness values above a prescribed threshold, the corresponding sub-region also being in prescribed proximity to a neighboring region in the brightness image having one or more brightness values below another prescribed threshold.

A twenty-first aspect corresponds to any combination (e.g., any permutation or subset that is not logically inconsistent) of the above-referenced first through twentieth aspects.

A twenty-second aspect corresponds to any method counterpart, device counterpart, system counterpart, means-plus-function counterpart, computer-readable storage medium counterpart, data structure counterpart, article of manufacture counterpart, graphical user interface presentation counterpart, etc. associated with the first through twenty-first aspects.

In closing, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A depth camera system for producing a depth image, comprising:
an imaging assembly configured to produce a sensor image based on return radiation reflected from a scene that has been irradiated by an illumination source, the imaging assembly including:
a transparent optical element (OE) through which at least the return radiation passes; and
a sensor on which the return radiation impinges after passing through the optical element, and which produces signals in response thereto,
the sensor image being formed based on the signals provided by the sensor;
a blur-mitigating component configured to deconvolve the sensor image with a kernel, to provide a blur-reduced image, the kernel representing a point spread function that describes distortion-related characteristics of at least the optical element; and
a depth-computing component configured to use the blur-reduced image to calculate a depth image, the depth image including depth values that reflect distances of objects in the scene with respect to a reference point.

2. The depth camera system of claim 1, wherein the depth camera system is configured to calculate the depth values using a time-of-flight technique.

3. The depth camera system of claim 1, wherein the depth camera system is incorporated as an element in a head-mounted display, and wherein the optical element is a visor element of the head-mounted display.

4. The depth camera system of claim 1, wherein the blur-mitigating component is configured to apply the kernel to an entirety of the sensor image.

5. The depth camera system of claim 1, further including a region-selecting component configured to select a sub-region of the sensor image to which the kernel is to be applied.

6. The depth camera system of claim 5,
wherein the depth camera system is further configured to generate a brightness image based, in part, on the sensor image, and
wherein the region-selecting component is configured to identify the sub-region of the sensor image by finding a corresponding sub-region in the brightness image having one more or brightness values above a prescribed threshold.

7. The depth camera system of claim 5,
wherein the depth camera system is further configured to generate a brightness image based, in part, on the sensor image, and
wherein the region-selecting component is configured to identify the sub-region of sensor image by finding a corresponding sub-region in the brightness image having one more or brightness values above a prescribed threshold, the corresponding sub-region also being in prescribed proximity to a neighboring sub-region in the brightness image having one or more brightness values below another prescribed threshold.

8. The depth camera system of claim 5, wherein the region-selecting component is configured to find an initial sub-region that satisfies a region-selection criterion, and then to expand the initial sub-region by a prescribed amount.

9. The depth camera system of claim 8, wherein the prescribed amount is determined based on a size of the blur kernel.

10. The depth camera system of claim 1, wherein the imaging assembly includes one or more lenses, and wherein the point spread function also describes distortion-related characteristics of said one or more lenses.

11. The depth camera system of claim 1, wherein the point spread function is derived from a line spread function, and wherein the line spread function describes blur that is exhibited near an edge of a test object.

12. A method for mitigating image blur, comprising:
projecting radiation onto a test object in a test scene;
generating an optical element (OE)-included image in response to return radiation that is reflected from the test object, the return radiation being scattered when it passes through a transparent optical element (OE);
generating a line spread function that describes blur that is exhibited near an edge of the test object within the OE-included image;
generating a point spread function based on the line spread function, the point spread function corresponding to a kernel that represents distortion-related characteristics of at least the optical element; and
storing the kernel in a blur-mitigating component of a depth camera system, for runtime use by the depth camera system in removing blur caused by the optical element.

13. The method of claim 12, further comprising, before said storing:
generating an OE-omitted image in response to OE-omitted return radiation that is reflected from the test object, the OE-omitted return radiation not passing through the transparent optical element;
applying the kernel to the OE-omitted image, to produce a synthetic image; and
comparing the synthetic image with the OE-included image to determine a degree of similarity between the synthetic image and the OE-included image.

14. The method of claim 12, wherein said generating of the line spread function comprises:
selecting a sample region on an edge in the OE-included image;
determining intensity values of a series of pixels which extend from a point on the edge in a given direction, for a plurality of points along the edge within the sample region; and
modeling the intensity values of the pixels which extend from the edge.

15. The method of claim 12, further comprising, in a runtime phase:
projecting radiation onto a runtime-phase object in a runtime-phase scene;
generating a runtime-phase sensor image in response to runtime-phase return radiation that is reflected from the runtime-phase object, the runtime-phase return radiation passing through the transparent optical element;
deconvolving the runtime-phase sensor image with the kernel, to provide a blur-reduced image; and
using the blur-reduced image to calculate a depth image, the depth image including depth values that reflect distances of objects in the runtime-phase scene with respect to a reference point.

16. The method of claim 15, further including selecting a sub-region of the runtime-phase sensor image to which the kernel is to be applied based on a threshold value determined in the calibration phase.

17. A computer-readable storage medium for storing computer-readable instructions, the computer-readable instructions, when executed by one or more processor devices, performing a method that comprises:
receiving a sensor image that is generated in response to return radiation that is reflected from an object in a scene, the return radiation being scattered when it passes through a transparent optical element (OE);
deconvolving the sensor image with a kernel, to provide a blur-reduced image, the kernel representing a point spread function that describes distortion-related characteristics of at least the optical element; and
using the blur-reduced image to calculate a depth image, the depth image including depth values that reflect distances of objects in the scene with respect to a reference point.

18. The computer-readable storage medium of claim 17, wherein the method further comprises selecting a sub-region of the sensor image to which the kernel is to be applied.

19. The computer-readable storage medium of claim 18,
wherein the method further comprises generating a brightness image based, in part, on the sensor image, and
wherein said selecting includes identifying the sub-region of the sensor image by finding a corresponding sub-region in the brightness image having one more or brightness values above a prescribed threshold.

20. The computer-readable storage medium of claim 18,
wherein the method further comprises generating a brightness image based, in part, on the sensor image, and
wherein said selecting includes identifying the sub-region of sensor image by finding a corresponding sub-region in the brightness image having one more or brightness values above a prescribed threshold, the corresponding sub-region also being in prescribed proximity to a neighboring region in the brightness image having one or more brightness values below another prescribed threshold.
